(19) United States
(12) Patent Application Publication
(10) Pub. No.: US 2005/0134566 A1
(43) Pub. Date: Jun. 23, 2005

(54) Computer input device for scrolling windows applications

(75) Inventors: Zhi-Heng Nian, Taipei (TW); Dong-He Dai, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 10/742,814

(22) Filed: Dec. 23, 2003

(51) Int. Cl. G09G 5/08

(52) U.S. Cl. 345/163

(57) ABSTRACT

A computer input device includes a control unit, a coordinate detecting module for detecting movement of the input device on a working surface, a roller on the body of the input device for generating a first scrolling signal, and a function key. When a user activates the function key and moves the input device, then the control unit will generate a second scrolling signal to cause both horizontal and vertical scrolling in response to detection of movement by the coordinate detecting device.

### BACKGROUND OF THE INVENTION

1. Field of the Invention

The present invention relates to a computer input device, and in particular, to an input device for scrolling a windows application. The input device provides a scrolling mode, in which, when a button or function key is pressed, movement of the input device over a working surface causes scrolling of the display in vertical and horizontal directions.

2. Description of the Prior Art

A well-known device for scrolling windows applications is disclosed in U.S. Pat. No. 5,530,455. The device is in the form of a roller on the top of a mouse for vertically scrolling the displayed content of a Windows™ application. If a user wishes to scroll the content differently, the user has to additionally press a Shift key on a keyboard and then rotate the roller to scroll the content horizontally, as described in col. 8, lines 60˜65 of U.S. Pat. No. 5,530,455. Alternatively, if the user is willing to spend more energy, the user can move the cursor to the horizontal scrolling bar and rotate the roller to scroll the horizontal scrolling bar.

In order to overcome the defect mentioned above, an input device with a twin roller structure is disclosed in China publication CN4308914. However, the twin roller structure is costly, and in addition is inconvenient since it is difficult for a user to move his finger between rollers in order to select a correct roller to rotate.

### SUMMARY OF THE INVENTION

It is an object of the present invention to provide a computer input device for scrolling displayed content of a Windows™ application alternatively in a vertical and horizontal direction.

It is another object of the present invention to provide a computer input device in which a vertical and horizontal scrolling function is activated by pressing a button rather than by rotating a scroll wheel.

To accomplish the virtues described above, the input device according to present invention comprises a control unit, a coordinate detecting module for detecting a movement of the input device on a working surface and moving a cursor on a display, a roller on the body of the input device for generating a first scrolling signal, and a function key. If a user actives the function key, the control unit will generate a second signal to cause vertical and horizontal scrolling of the content of a Windows™ application in response to movement of the input device on the working surface, as detected by the coordinate detecting module, rather than in response to first signal based on movement of the roller.

### BRIEF DESCRIPTION OF THE DRAWINGS

FIG. 1 is a block diagram according to the present invention.

FIG. 2 is a flow chart diagram according to the present invention.

FIG. 3A is a diagram showing a connection with a computer system.

FIG. 3B is a diagram showing activation of a function key.

FIG. 3C is a diagram showing activation of the function key and the movement of the input device.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

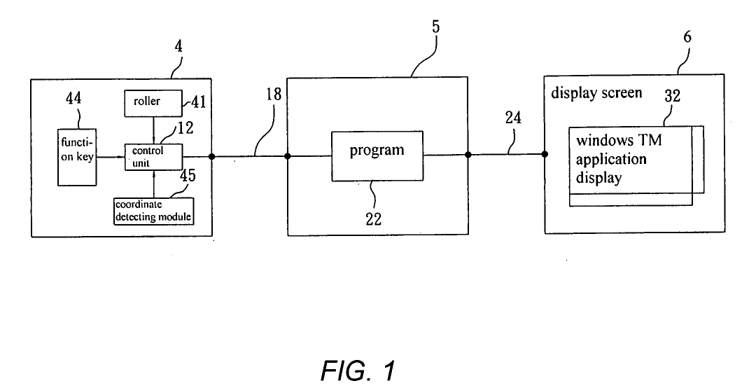

Referring to FIG. 1, the input device 4 has a control unit 12 and coordinate detecting module 45. Input device 4 may take the form of a computer mouse, a trackball, a keyboard, a touch pad, or the like, and may be a wired or wireless device. The control unit 12 receives signals from function key 44, roller 41 and coordinate detecting module 45, processes the signals by means of firmware, and sends appropriate scrolling and cursor control signals to the computer. The coordinate detecting module generates coordinate signals that are normally used to control the position of a cursor on a display, while the roller generates scrolling signals used to scroll the display in a vertical direction. When horizontal and vertical scrolling is desired, the user presses the function key, as will be described in more detail below, the output of the coordinate detecting module is used to control scrolling of the display, rather than movement of the cursor, in response to movement of the input device.

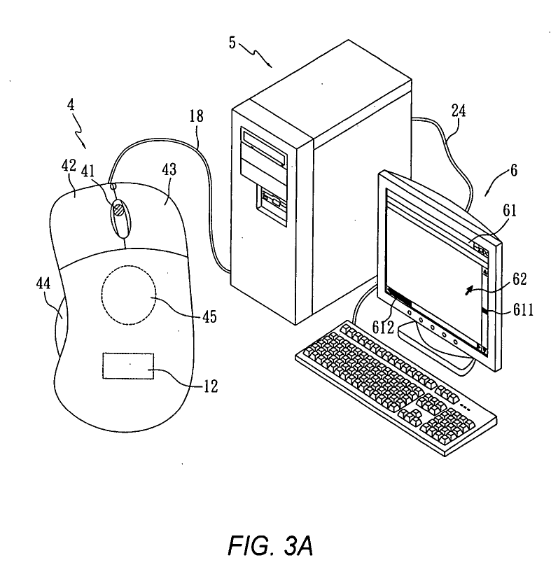

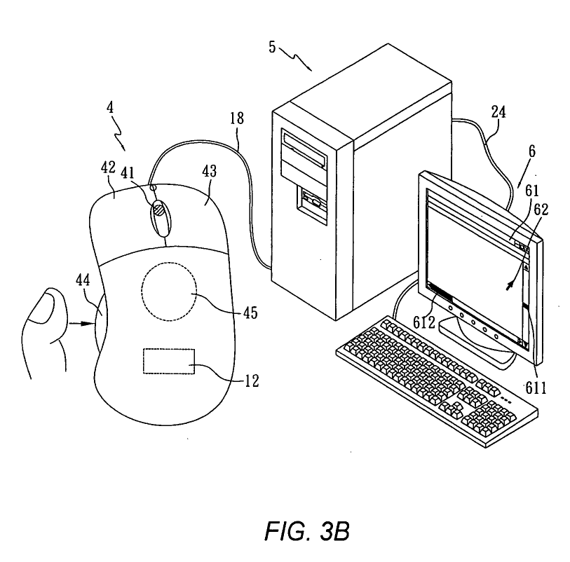

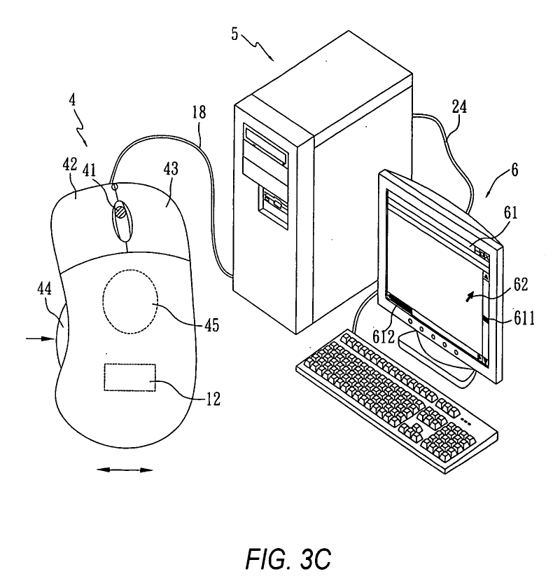

As shown in FIGS. 3A-3C, the input device 4 is a computer mouse and the function key 44 is an extra button apart from the known button 42 for clicking (left button) and the other known button 43 for opening a function block (right button). Returning to FIG. 1, the input device 4 communicates with the an input/output program 22 included in the operating system of a computer 5 via an interface 18 so as to control a movement of a cursor on a display screen 6. The operating system is preferably a version of Microsoft Windows™. The display screen 3 displays the application being executed, which in the illustrated example is a Windows™ application 32.

Referring to FIG. 3A, the control unit receives signals from function key 44, roller 41 and coordinate detecting module 45. The input device 4 communicates with computer 5 via interface 18 so as to control a movement of a cursor 62 on the display screen 6. The display screen 6 connects to the computer 5 via an interface 24 that permits display of a Windows™ application 61 being executed. The Windows™ application display has a vertical scrolling bar 611 and a horizontal scrolling bar 612. In addition, the computer 5 of this specific example has a program 22, which is typically part of the Windows™ operating system, for detecting the signals coming from the function key 44, roller 41 and coordinate detecting module 45.

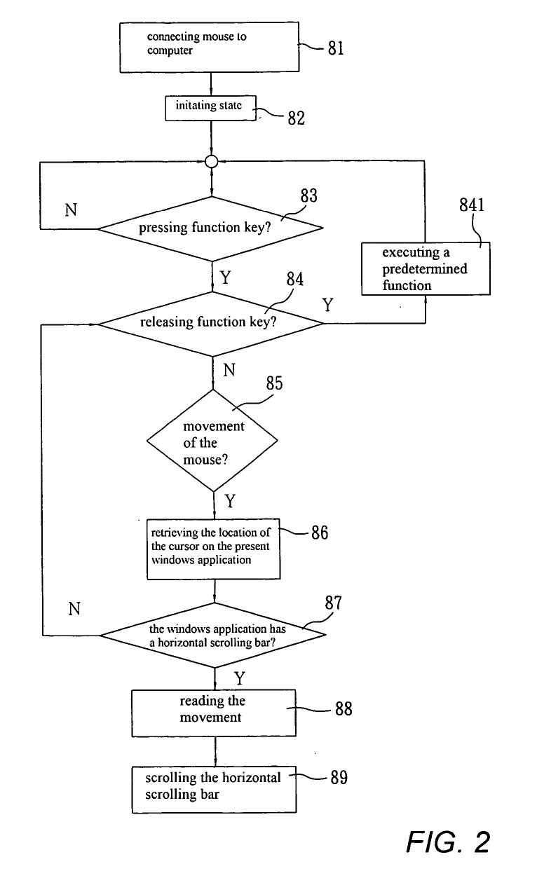

Referring to FIGS. 2 and 3B, a user moves the input device or mouse 4 on a working surface as to control the cursor 62 moving on the display 6. When the user rotates the roller 41, the control unit 12 generates a first signal to scroll the vertical scrolling bar 611.

If the user presses and releases the function key 44 (steps 83 to 84), the control unit 12 will generate a third signal to the program 22 in order to execute a predetermined command or function (step 841), such as page up, page down, windows application switching, multimedia device control . . . etc.

Referring to FIGS. 2 and 3C. If the user presses the function key 44 and moves the mouse 4 to the left or right direction (step 85), then the control unit 12 will send a second signal to the program 22. The program 22 will determine a position of the cursor on a present windows application (step 86), and whether the present Windows™ application has a horizontal scrolling bar 612 (step 87). If the Windows™ application has a horizontal scrolling bar 612, the program 22 will read the direction and the displacement thereof (step 88) so as to move the horizontal scrolling bar 612 to the direction (left or right) following a corresponding speed based on the displacement (step 89). If the present windows application does not have a horizontal scrolling bar 612 (step 87), the control unit 12 will determine if the function key 44 has been released (step 84). If yes, the program 22 will generate a third signal for executing a predetermined command or function (step 841). If not, the program 22 will determine if the mouse 4 has been moved to left or right direction (step 85).

Please notice that the further the displacement is, the faster the scrolling bar will move. When the displacement is horizontal, the horizontal scrolling bar 612 will scroll the content on the present windows application correspondingly. On the other hand, when the displacement is vertical, the vertical scrolling bar 611 will scroll the content on the present windows application correspondingly.

By the way, the function key 44 can be located at any desired position on the mouse 4, for example, at a higher or lower position than that of roller 41, or at a lateral side of the roller 41.

While the description above refers to particular embodiments of the present invention, it will be understood that many modifications may be made without departing from the spirit thereof. The accompanying claims are intended to cover such modifications as would fall within the true scope and spirit of the present invention.

1. An input device arranged to communicate with a computer for scrolling a displayed application, the input device comprising:
a control unit coupled to a coordinate detecting module, a roller and a function key;
wherein the coordinate detecting module detects a movement such that the control unit moves a cursor on a display of the computer in response to the detection of movement;
wherein an operation of the roller make the control unit send a first signal to the computer to cause scrolling of the displayed application in a single direction;
wherein when both the function key is activated and the coordinate detecting device detects the movement, the control unit sends a second signal to the computer; and
wherein the second signal selectively causes vertical scrolling, horizontal scrolling, or vertical and horizontal scrolling of the displayed application in response to detection of movement by the coordinate detecting device.

2. The input device as claimed in claim 1, wherein the computer has a program for receiving the first signal and the second signal to control scrolling of the display by displacing a vertical scrolling bar and a horizontal scrolling bar.

3. The input device as claimed in claim 1, wherein the control unit generates the second signal to control the scrolling of the display by displacing a vertical scrolling bar and a horizontal scrolling bar.

4. The input device as claimed in claim 1, wherein when the function key is activated, the control unit sends a third signal to execute a predetermined function or command.

5. The input device as claimed in claim 4, wherein the predetermined function or command is a multimedia device controlling function.

6. The input device as claimed in claim 1, wherein the function key is located on a surface of the input device.

7. The input device as claimed in claim 6, wherein the function key is located around the roller.

8. The input device as claimed in claim 1, wherein the input device is selected from the group consisting of a computer mouse, a trackball, a keyboard, and a touch pad.

9. The input device as claimed in claim 1, wherein the input device is a wireless input device.

10. The input device as claimed in claim 1, wherein the second signal controls a speed of the scrolling based on the amount of the movement.

11. The input device as claimed in claim 1, wherein when the movement is horizontal, the second signal controls the scrolling of the horizontal scrolling bar.

12. The input device as claimed in claim 1, wherein the display application is a Windows™ application.

13. The input device as claimed in claim 1, wherein when the movement is vertical, the second signal controls the scrolling of the vertical scrolling bar.
